(19) United States
(12) Patent Application Publication
(10) Pub. No.: US 2004/0217863 A1
(43) Pub. Date: Nov. 4, 2004

(54) Infrared detector

(76) Inventor: Jui-Hung Hsu, Tainan (TW)

Correspondence Address: BACON & THOMAS, PLLC, 625 SLATERS LANE, FOURTH FLOOR, ALEXANDRIA, VA, 22314

(21) Appl. No.: 10/424,824

(22) Filed: Apr. 29, 2003

(51) Int. Cl. G08B 13/18

(52) U.S. Cl. 340/556

(57) ABSTRACT

An infrared detector includes a light emitter and a light receiver. The light emitter has plural light emitting units with a circuit connecting the light emitter with a CPU programmed decoder and a power amplifying controller, and then a special coded signal amplified and emitting out with infrared light beam by the light emitting units to the light receiver. The light receiver has plural infrared light receiving units and a circuit connecting the receiving units with a signal amplifier, a CPU programmed calculating and comparing decoder, and an output controller. The special coded signal with infrared light beam received by each separate infrared light receiving unit is sent at once to the signal amplifier for amplifying, and then fed to the CPU programmed calculating and comparing decoder for processing, and the controlled by the output controller, so as to prevent the infrared detector from disabled by unauthorized code or different code by illegally intending person.

### BACKGROUND OF THE INVENTION

1. Field of the Invention

This invention relates to an infrared detector, particularly to one highly protecting security to improve disadvantages of a conventional infrared detector liable to be disabled to lose its function.

2. Description of the Prior Art

A traditional common infrared detector generally includes a light emitter, and a light receiver combined together. Its operational way is that the light emitter and the light receiver are positioned to face each other and spaced apart with a preset distance within an effective scope. Then the light emitter emits infrared light beam with a code, such as a lane-style protective light beam to the light receiver, and when anyone or a thief should walk through the gap between the light emitter and the light receiver to interrupt the infrared light beam from being received by the light receiver, a protective appliance such as a threatening lamp or an alarm may be automatically triggered to call attention by the infrared detector. Many buildings use this kind of infrared detector for security defense. Further, the infrared detectors have a single-lane light beam, a double-lane light beam or multi-lane light beam, and especially the double-lane ones are popularly used, as it can prevent such wrong action as caused by a falling leaf or the like. Its operation principle is using two units of infrared light emitting units for the light emitter and two light receiving units for the light receiver positioned spaced apart with a proper distance, and if one of the two units should be interrupted by something, the light receiver still does not function so as to prevent the light detector from functioning caused by unrelated things such as falling leaves, insects, birds, etc. Only when the two lanes of the infrared light beam are at the same time interrupted, the light detector will operate to turn on a lamp or an alarm.

Though the conventional infrared detectors can attain the purpose of using double-lane infrared light beam for detecting intrusion, they are quite unsafe detecting systems in practical use. FIG. 1 shows how the conventional infrared detector performs its function, including double-lane infrared light emitting units 1A and 1B of a light emitter 1 for giving out two lanes of infrared light beam, and two light receiving units 2A and 2B for receiving the infrared light beam coming from the light emitting units 1A, 1B. But it has the following disadvantages.

1. As to its effect: If a person wants to disable the conventional infrared detector, he can easily do it by using another light emitter 3 of the same trademark or the different trademark and giving out infrared light beam by means of its two light emitting units 3A and 3B at a shorter distance than that between the original light emitter 1 and the original light receiver 2 as shown in FIG. 1, with only one of the light beam of the two emitting units 3A or 3B received by one of the light receiving units 2A or 2B, or with the two light beam giving out by the two emitting units 3A and 3B both received by the two light receiving units 2A and 2B. Then the effective distance may become only the distance represented by the L in FIGS. 1 and 2, with the distance shown by the L1 in FIGS. 1 and 2 between the light emitting units 1A and 1B and those 3A and 3B loses protective effect to permit a thief pass across the light beam without triggering the light receiver 2 to function. In other words, the conventional infrared detector is nominal but unsubstantial, prone to be disabled by another infrared light emitter.

2. Even if a would-be thief makes out which is the light receiver, the person can use two sets of the light emitters to emit infrared light beam to both the light emitter and the light receiver to make the light receiver lose function so as to commit illegal action.

3. For keeping secret: The information used between the light emitter and the light receiver of the convention a infrared detector is a constant single code, nearly impossible to keep secret.

4. As to security: The conventional infrared detector cannot maintain protection against illegal use of other infrared emitters, not safe to use.

### SUMMARY OF THE INVENTION

The purpose of the invention is to offer an infrared detector, improved to have function and protection against illegal measures of disabling by other infrared emitters, completely protected against intentional breaking by thieves.

The infrared detector in the invention has a light emitter provided with plural infrared light emitting unit for emitting separately infrared light beam and electronically connected with a CPU programmed encoder, and a power amplifying controller. The CPU programmed encoder calculates, processes and produces special codes to be controlled by the power amplifying controller and then fed to the infrared light emitting units of the light emitter, which focuses the infrared light beam and then projects it to a far-away light receiver. Then the light receiver receives the infrared light beam coming from the light emitter and feeds it to a signal amplifier, and then to a CPU programmed comparing decoder and then to an output controller. Other different codes used by an illegally intending thief cannot disable anyone of the light-receiving units of the light recover in the infrared detector.

### BRIEF DESCRIPTION OF DRAWINGS

This invention will be understood better by referring to the accompanying drawings, wherein:

FIG. 1 is a diagram of a conventional infrared detector being decoded by another infrared light emitter;

FIG. 2 is another diagram of the conventional infrared detector being disabled infrared light beam emitted by another infrared light emitter;

FIG. 3 is a block diagram of a preferred embodiment of an infrared detector in the present invention;

FIG. 4 is a diagram of an electronic circuit for a light emitter in the present invention; and,

FIG. 5 is a diagram of an electronic circuit for a light receiver in the present invention.

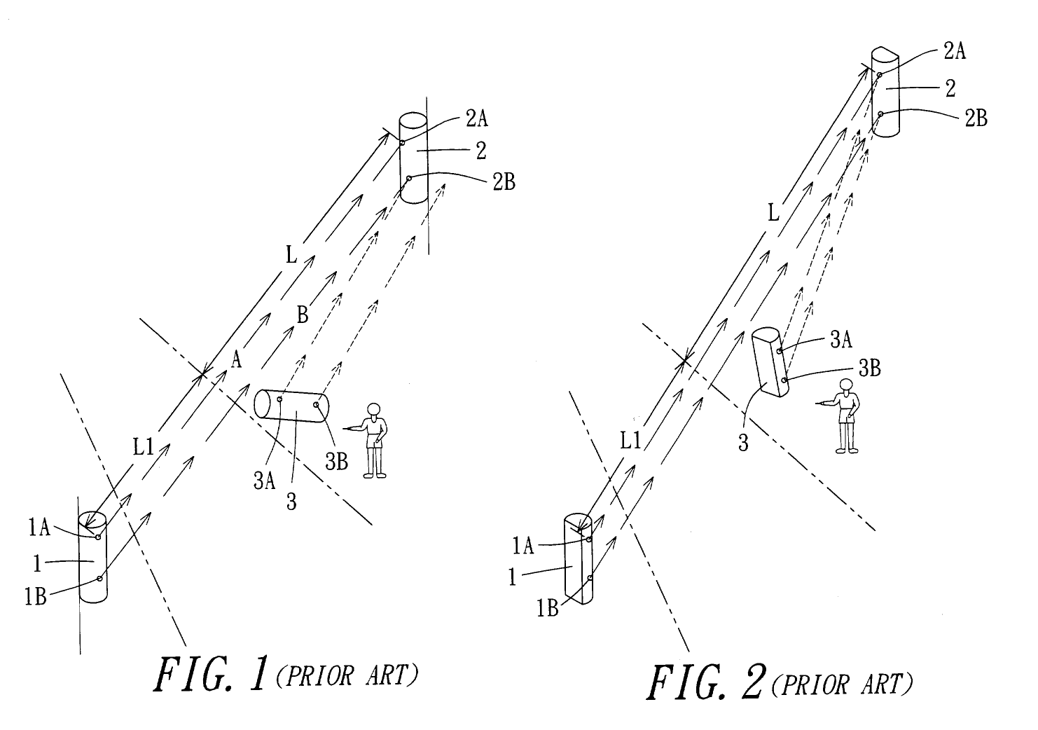

### DETAILED DESCRIPTION OF THE PREFERRED EMBODIMENT

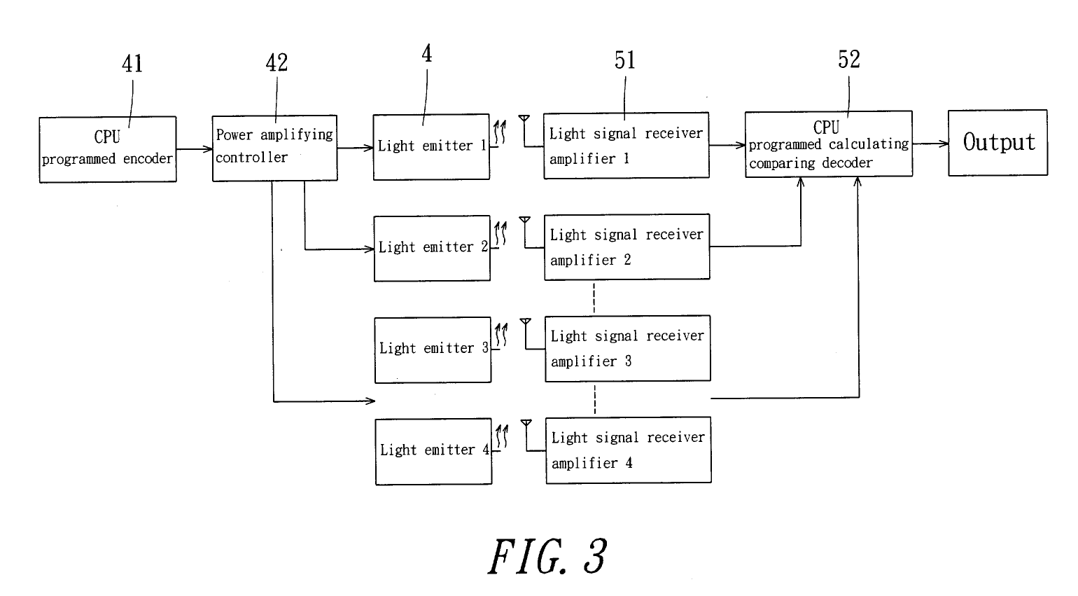

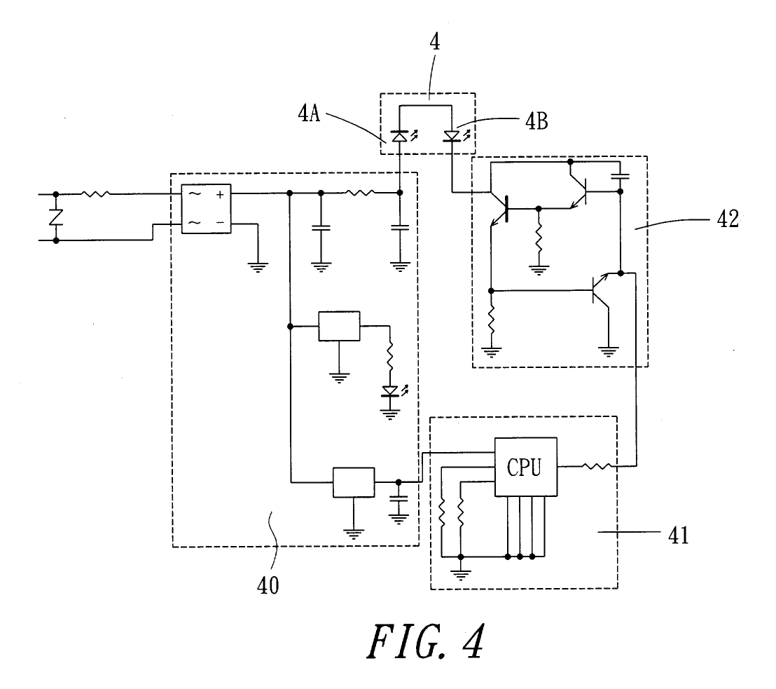

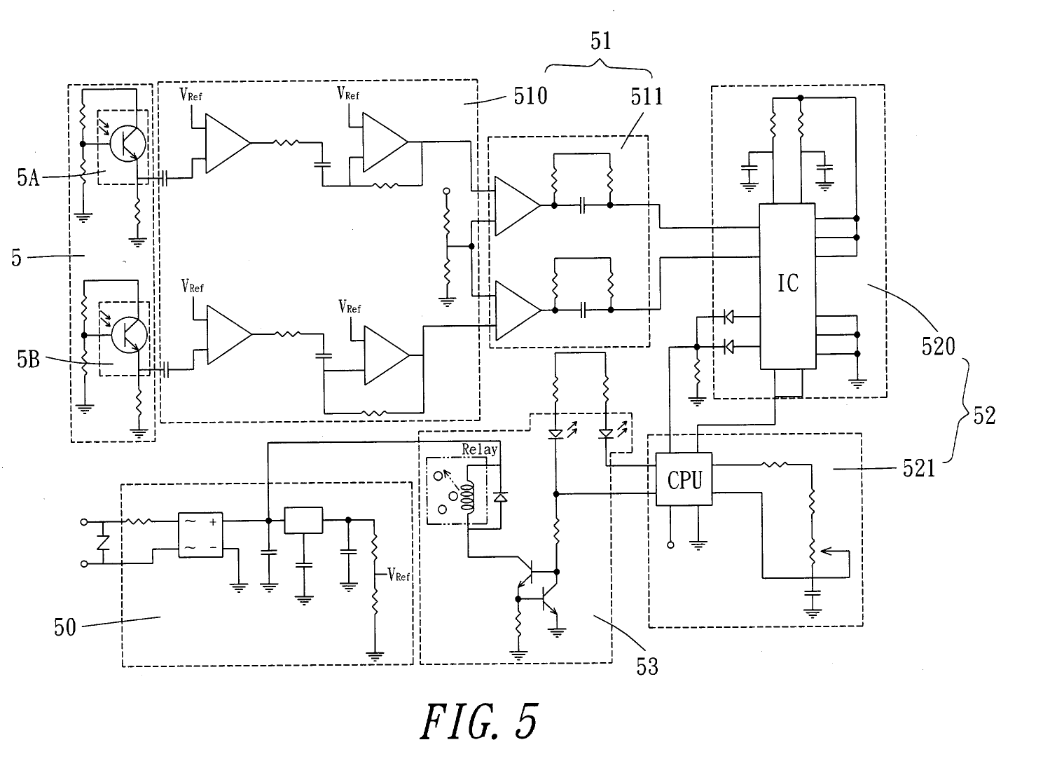

A preferred embodiment of an infrared detector in the present invention, as shown in FIG. 3, includes a light emitter 4 consisting of two double-lane infrared light emitting units 4A and 4B, and an electronic circuit 40 of the light emitter 4, a CPU programmed encoder 41, a power amplifying controller 42 (referring to FIG. 4), a light receiver 5 consisting of two double-lane infrared light receiving units 5A and 5B, an electronic circuit 50 of the light receiver 5, a signal amplifier 51, a CPU programmed decoder 52, and an output controller 53.

At first, a special code is produced by the CPU programmed encoder 41, and the code is not to be repeated and then mixed with an irregular random number for preventing the special code from decoded. The signal controlled by the special code added with a random number is produced by the CPU programmed encoder 41 and then amplified by the power amplifying controller 42 and then the light emitting units 4A and 4B of the light emitter 4 at first focuses and projects the infrared light beam containing the code controlled signal to the far-away light receiver 5.

The light receiver 5 receives the infrared light beam coming form the light emitter 4 and feeds it to the signal amplifier 51, which consists of a small signal amplifier 510 and a wave rectifier 511. Then the small signal amplifier 510 amplifies the received signal and through the wave rectifier 511 transmitted to the CPU programmed decoder 5, which consists of a comparing controller 520 and a CPU decoder 521. Then the CPU decoder 521 compares the received signal with a single code preset therein to carry out a proper measure.

As each infrared light receiving unit 5A, 5B, of the light receiver 5 is designed as an independent calculating element, each infrared signal with the special code of the light emitter 4 received by the infrared receiving unit 5A or 5B is calculated separately by the CPU programmed decoder and then compared separately, i.e. each lane infrared light beam is separately calculated and compared for decoding, therefore even if one of the infrared light receiving unit 5A or 5B produces an unexpected condition, the other infrared light receiving unit 5A or 5B cannot be affected in its discerning and calculating, acquiring effective and sufficient security defense.

It is quite clear that in practical use the infrared detector in the invention cannot be decoded or disabled by a person with illegal intention to project infrared light to one of the light receiving units of the light receiver in the invention, as the infrared light receiving unit in the invention is impossible to be triggered to function by infrared light containing an unauthorized code or a different code, with the output controller 53 in line with other appliance such as a threatening lamp, or alarm automatically not triggered to turn on. So the infrared detector in the invention has a complete security defense, improving the traditional infrared detector in its susceptible weakness of decoding or disabling.

Further, one worthy point to be noted in the present invention is that the number of lanes of the inferred beam is not limited to the double-lane, but single-lane, three-lane or multi-lane can be applied. In addition, the CPU programmed encoder 41 can match with plural light emitters 4, as shown in FIG. 3.

While the preferred embodiment has been described above, it will be recognized and understood that various modifications may be made therein and the appended claims are intended to cover all such modifications that may fall within the spirit and scope of the invention.

What is claimed is:

1. A infrared detector comprising:
A light emitter having one or more infrared light emitting units and a circuit connecting said light emitter electronically with a CPU programmed encoder and a power amplifying controller, said CPU programmed encoder performing calculation and processing for producing a special coded signal, said special coded signal emitted out with infrared light beam by said infrared light emitting units to a light receiver positioned far away from said light emitter;
Said light receiver having plural infrared light receiving units for receiving the infrared light beam with the specially coded signal coming from said infrared light emitting units of said light emitter, an electronic circuit connecting electronically said light receiver with a signal amplifier, a CPU programmed decoder for calculation and comparing and an output controller;
Each infrared receiving unit of said light receiver independently receiving each separate infrared light beam with the special coded signal to be separately transmitted at once to said signal amplifier for amplifying and then fed to said CPU programmed decoder for calculating and comparing and then automatically controlled by said output controller.

2. The infrared detector as claimed in claim 1, wherein said received signal amplifier consists of a small signal amplifier and a wave rectifier.

3. The infrared detector as claimed in claim 1, wherein said CPU programmed calculation and compare decoder consists of a compare controller and a CPU decoder.
